(19) United States
(12) Patent Application Publication
(10) Pub. No.: US 2020/0193872 A1
(43) Pub. Date: Jun. 18, 2020

(54) DEVICE FOR SIMULATING A SURGICAL INTERVENTION

(71) Applicant: NCS LAB S.R.L., 41012 CARPI (MODENA) (IT)

(72) Inventor: MATTEO MANTOVANI, CARPI (IT)

(21) Appl. No.: 16/642,456

(22) PCT Filed: Jun. 25, 2018
(86) PCT No.: PCT/IB2018/054646

§ 371 Date: Feb. 27, 2020

(30) Foreign Application Priority Data
Aug. 29, 2017 (IT) 102017000096936

(51) Int. Cl. G09B 23/32; G09B 23/34

(52) U.S. Cl. CPC G09B 23/32; G09B 23/34

(57) ABSTRACT

A device for simulating a surgical intervention, comprising: a first support (2), which defines a first reference plane (2a) and a second reference plane (2b); said reference planes can vary the angle with an appropriate system of movement (e.g. manoeuvring screw, inclined surface, air- or liquid-driven actuation system, electric motor, etc.) to simulate the range of motion of the joint, which is appropriately varied intraoperatively in various steps of the intervention (to enable or facilitate some steps of the intervention); a second support (3), provided with a seat (31) for accommodating a portion of bone or of a bone model, which is associated with the first support (2) with the possibility of rotating about at least a first axis (X) parallel to a longitudinal axis of the portion of bone or bone model. The whole joint structure is enclosed inside a casing simulating the volume of soft tissues. The casing is workable for the purpose of recreating portals or operating access routes. Inside the casing there are consumable elements that contribute to defining

The present invention relates to a device for simulating a surgical intervention, in particular for simulating an orthopaedic surgical intervention performed by means of arthroscopy.

As is well known, numerous orthopaedic surgical interventions can be performed by means of arthroscopy. Some examples are represented by interventions performed on joints to reconstruct tendons and ligaments, suture menisci, remove bone fragments and so on.

In many cases, arthroscopic surgical interventions entail performing partial abrasions or fashioning one or more holes passing through the end of a bone, necessary to secure ligatures or stitches which serve to fix the edge of a ligament or tendon to the bone. The holes are created using an instrument that is introduced through a small incision or hole made through the epithelial and muscular tissues which cover the bone involved in the intervention. Correct positioning of the instrument is facilitated by the use of optical instruments such as, for example, micro cameras, which are positioned in proximity to the bone, in the area in which the abrasion or hole must be created.

For the correct positioning of the hole or abrasion, the correct positioning of the bone, or joint of the patient, at the time of performing the intervention is fundamental. For example, in the case of an intervention to reconstruct a rotator cuff, the angular position of the humerus relative to its longitudinal axis, both in terms of abduction/adduction and intra/extra rotation, is fundamental. In the case of an intervention to reconstruct the ligaments of a knee, the angular position of the tibia relative to its longitudinal axis is fundamental.

It is therefore evident that a surgeon, in order to be able to perform a correct intervention, needs to know with great precision the effect produced by the correct or incorrect positioning of a joint or of a bone, with particular reference to the position of the anatomical landmarks relative to the position of the portals. Improper positioning of the latter may heavily influence the success of the procedure. This effect should reasonably not be explored in the course of an intervention, but should rather derive from a certain degree of experience acquired during trials and tests performed on models.

At present, however, there are no available models or simulator devices that allow joints, or at least the positioning of a bone of a joint, to be effectively reproduced. This means that a surgeon often does not have a full perception of to what degree the incorrect positioning of a bone or joint may lead to an insufficient outcome of the intervention performed, especially in the event that newly conceived instruments are used.

The object of the present invention is to offer a device for simulating a surgical intervention which enables the limitations presently observable in the art to be overcome.

Characteristics and advantages of the present invention will more fully emerge from the following detailed description of an embodiment of said invention, as illustrated in a non-limiting example in the accompanying drawings, in which:

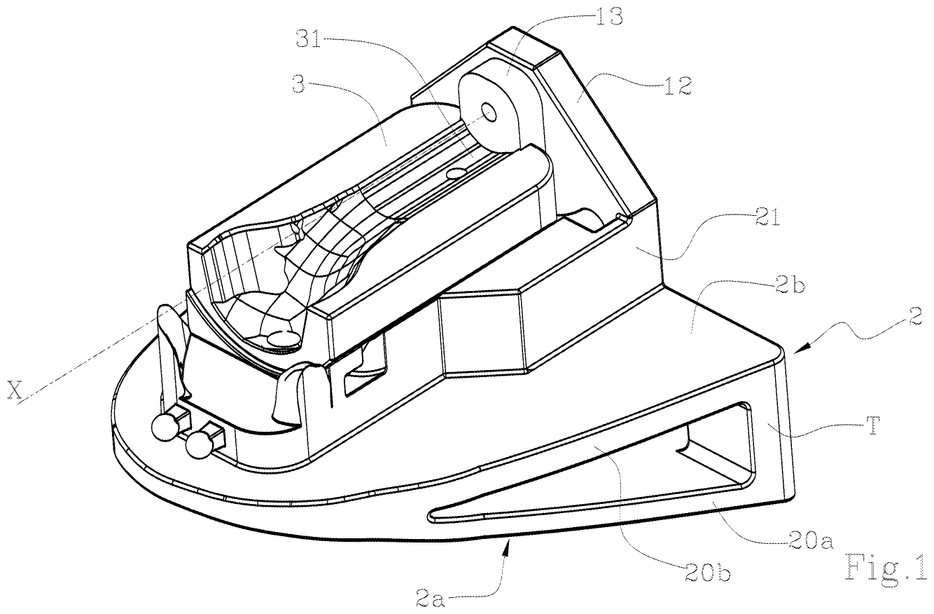

FIG. 1 shows an isometric view of the device according to the present invention;

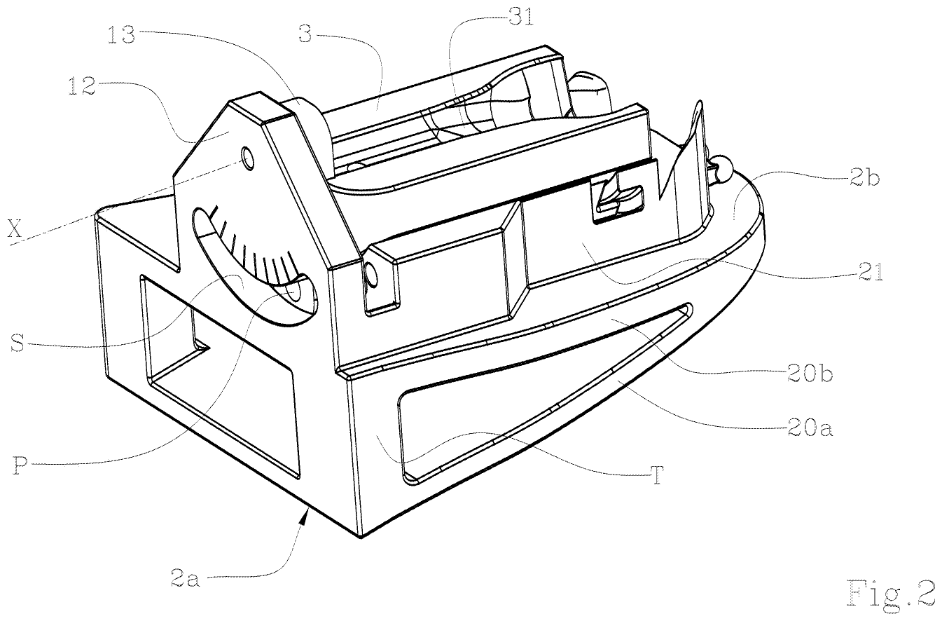

FIG. 2 shows a second isometric view of the device according to the present invention, from a different point of view;

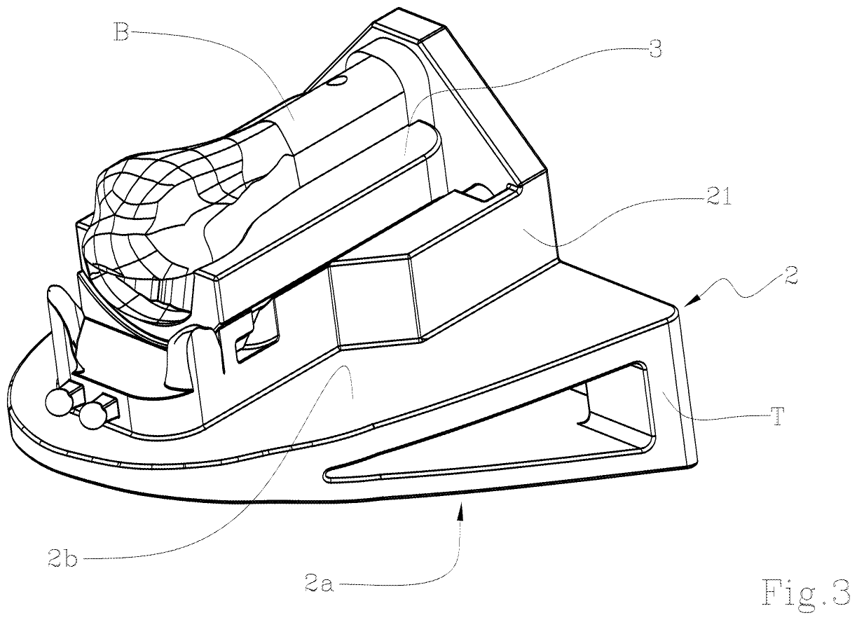

FIG. 3 shows the device of FIG. 1, on which a model of a bone is disposed (B);

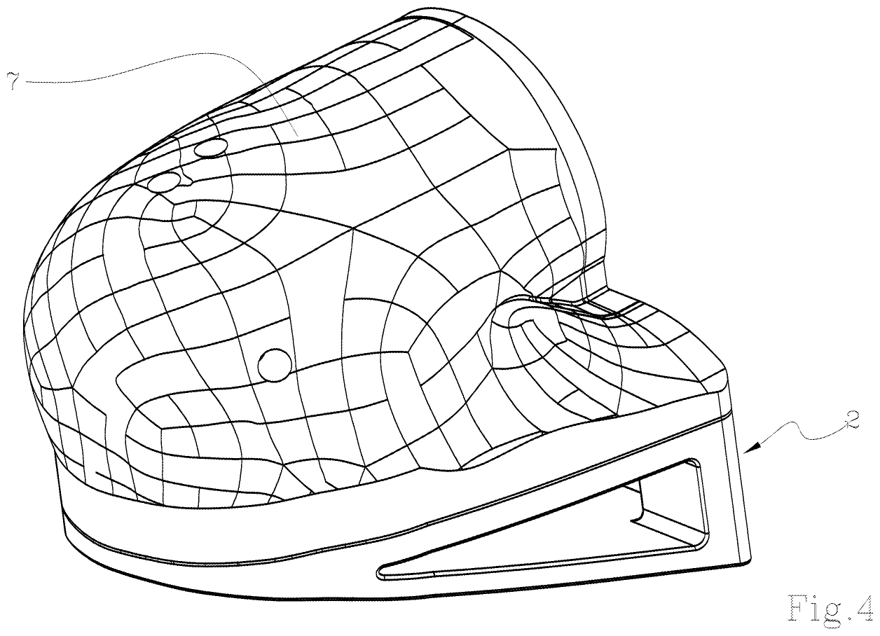

FIG. 4 shows the device of FIG. 1, on which quale a casing is disposed (7);

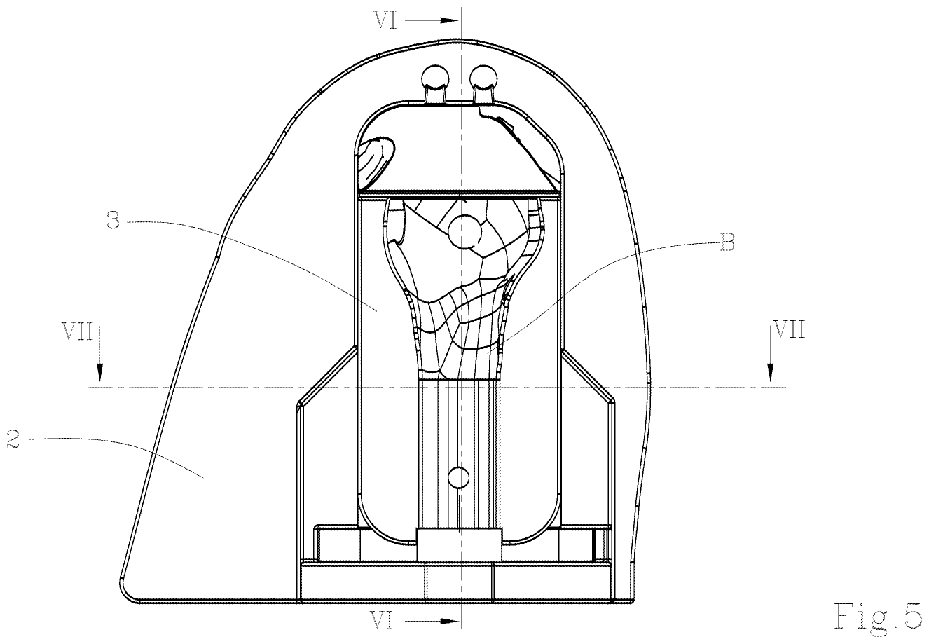

FIG. 5 shows a top view of the device of FIG. 3;

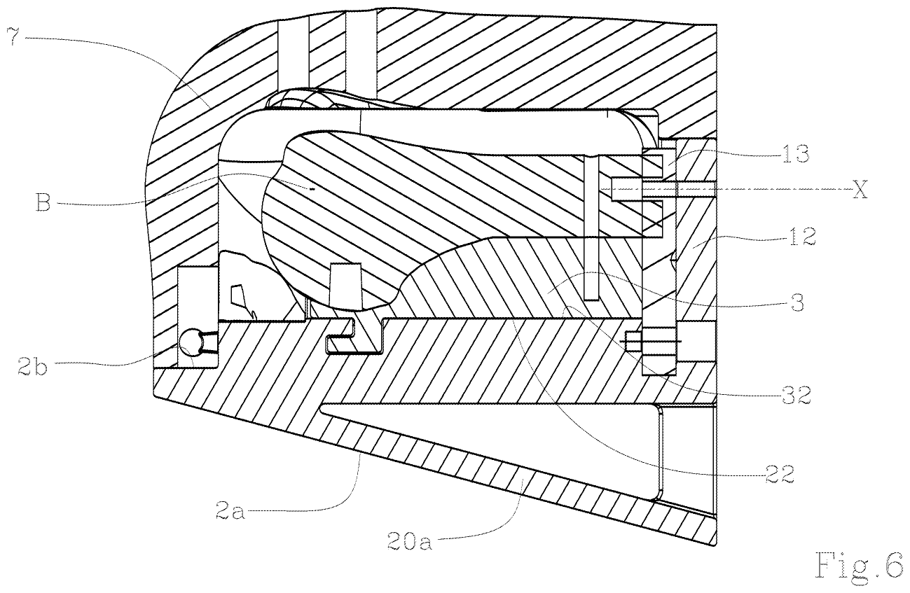

FIG. 6 shows a sectional view on the plane VI-VI of FIG. 5;

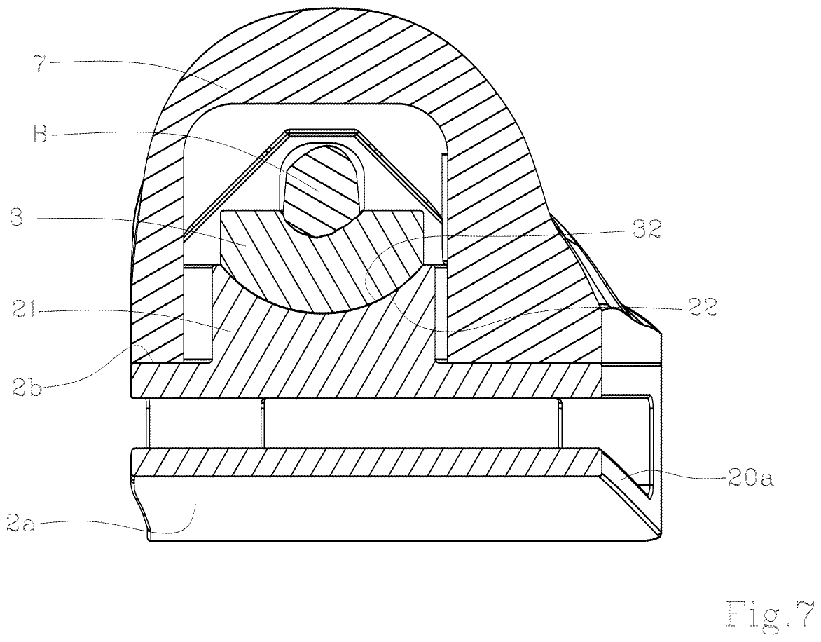

FIG. 7 shows a sectional view on the plane VII-VII of FIG. 5.

In the description that follows, reference will be made to an intervention to be performed on the head of the humerus, for example for the reconstruction of the rotator cuff. This does not mean that the device according to the present invention cannot simulate interventions on other bones or other joints.

The device according to the present invention comprises a first support (2), which defines a first reference plane (2a) and a second reference plane (2b). In particular the plane (2a) is useful for positioning the anatomical model in the various positions typically used during this type of surgery, for example the “beach chair” or lateral decubitus position. The orientation and inclination of the planes (2a,2b) in space can preferably be varied during the simulation, substantially as occurs during a real surgical intervention in an operating setting. The joint range can vary between 0 and 90° and may be controlled in various ways. Some possible means for varying the angle of inclination of the first and/or second plane (2a,2b) can comprise a manoeuvring screw, an inclined surface, an air- or liquid-driven actuation system, an electric motor or the like.

The first plane (2a) can be, for example, a surface used to fix the device to a bench or worktop, or to another supporting structure.

The second plane (2b) can be used as a first reference for defining the position of the bone, or bone model (B), on which the intervention must be performed. For example, in the case of a simulation of an intervention on the head of the humerus, the second plane (2b) defines the reference for the inclination of the humerus on the coronal plane of the human body (abduction/adduction angle). Essentially, the angle existing between the first plane (2a) and the second plane (2b) defines, on the coronal plane of the body, the angle of inclination of the humerus or of the model thereof relative to the body, so that this inclination substantially coincides with the inclination of the humerus under conditions of a real intervention. The first plane (2a) can provide for different positions of fixing to the workbench, which have the purpose of representing the various positions that are normally assumed by the patient on the operating table. In this manner, the operator finds himself practicing under exactly the same conditions as he normally operates under. The variation of the angle between the first plane (2a) and second plane (2b) enables a better understanding of how the variation in the position influences the surgical technique.

In the embodiment represented, the first plane (2a) is identified on the lower surface of a rest plate (20a), which can be provided with a means for fixing to a support surface or structure. The rest plate (20) can be fixed in a substantially horizontal position to simulate an intervention with the patient in the lateral decubitus position, or else in a substantially vertical position to simulate an intervention in the beach chair position. Other intermediate positions can be obtained by adopting a further inclined plane which can be interposed between the reference plane or rest bench and the first plane (2a).

The second plane (2b) can be identified by a second plate (20b), associated with the rest plate (20a) and inclined relative to the latter by an angle that is prefixed or variable, thus enabling a further degree of freedom to be obtained. The two plates (20a,20b) can be connected to each other by means of one or more transverse portions (T), as in the embodiment represented, wherein the plates (20a,20b) are connected to each other at a first end, whilst at a second end they are connected by a transverse portion (T). In a further possible embodiment, the support (2) can be provided with a means to enable adjustment of the inclination between the first plane (2a) and the second plane (2b). For example, the adjustment means enables adjustment of the inclination between the rest plate (20a) and the second plate (20b). This enables a simulation of various inclinations of the humerus on the coronal plane.

The device according to the present invention further comprises a second support (3), provided with a seat (31) for accommodating a portion of bone or of a bone model. In the embodiment represented, the seat (31) has a cradle-like conformation, shaped in such a way as to be able to receive an end portion and the head of a model of the humerus. For this purpose, the seat (31) comprises an end portion having a convex conformation and greater depth, shaped to receive the head of the humerus, which is connected to a portion having a cylindrical conformation and less depth. Fixing means can be provided to fix the bone model to the seat (31), for example screws or other equivalent means.

The second support (3) is associated with the first support (2) with the possibility of rotating about at least a first axis (X) parallel to a longitudinal axis of the bone model. The allowed degrees of freedom are all or part of those of the joint which is the subject of the simulation.

The possibility of rotating the second support (3) relative to the first support (2) about the first axis (X) enables a very effective simulation of a determinant condition for the correct execution of an intervention that entails a mechanical operation to be performed in a precise position on the surface of the head of the humerus. This condition is represented by the angular position of the humerus relative to its longitudinal axis. For example, in the case of a rotator cuff reconstruction intervention, it is necessary to perform two mechanical operations on the head of the humerus. Said operations include an abrasion of the cortical bone, aimed at producing bleeding which facilitates the adhesion of the end of the tendon, and the fashioning of a through hole for securing a suture. The abrasion of the cortical bone must be performed and the through hole fashioned on the coronal plane of the humerus. It is thus evident that, if the humerus is not in the correct angular position relative to its longitudinal axis, the coronal plane will not be in the foreseen position relative to the portal created through the soft tissues. Consequently, the performance of the two operations described above, which require access to the head of the humerus through the soft tissues of the shoulder, may take place in an incorrect position. Thanks to the possibility of rotating the second support (3) relative to the first support (2) about the first axis (X), the device according to the present invention enables the effect due to the angular position of the humerus relative to its longitudinal axis to be simulated in an extremely effective manner, by simulating, in the case of a shoulder, a manoeuvre of intra/extra rotation. In this way, the surgeon is able to gain the necessary experience for performing a correct intervention solely through experimental trials conducted with the aid of the device according to the present invention.

In the embodiment represented, the first axis (X) is parallel to the second plane (2b). In this manner, the inclination of the axis of the humerus on the coronal plane is influenced only by the inclination of the second plane (2b) relative to the first plane (2a). In a possible embodiment, the inclination of the first axis (X) could be adjustable relative to the second plane (2b) and/or relative to the first plane (2a).

In the embodiment represented, the first support (2) comprises a coupling portion (21) provided with a cylindrical surface (22) concentric to the first axis (X). The coupling portion (21) projects from the second plate (20b), on the opposite side relative to the rest plate (20a).

The second support (3) comprises a cylindrical surface (32) concentric to the first axis (X) and placed in contact with the coupling portion (21). In this manner it is possible to make the longitudinal axis of the bone approximately coincide with the first axis (X).

Essentially, the second support (3) is in the form of a cradle disposed in contact with the first support (2) on the cylindrical surface (32). The cylindrical surface (32) of the second support (3) is placed in contact with the cylindrical surface (22) of the first support (2) and can slide relative to the latter according to a circular motion about the first axis (X). For this purpose, the first support (2) and the second support (3) are provided with a respective bracket (12,13), each of which has a hole concentric to the first axis (X) intended to receive a rotation pin (not illustrated). In the embodiment represented, the brackets (12,13) are substantially in the form of plates parallel to each other and perpendicular to the first axis (X).

A manoeuvring means (not illustrated) may be provided to bring about the rotation of the second support (3) relative to the first support (2). For example, the manoeuvring means can comprise a stem or a knob, associated with the second support (3) in a seat (P) (FIG. 2) and set in a position so as to be graspable by a user. A locking means (not illustrated) can be further provided to lock the second support (3) in a desired angular position relative to the first support (2). The locking means can for example be configured to produce high friction between the first support (2) and the second support (3), for example by means of a screw or a screw mechanism disposed through an arched seat (S) fashioned in the bracket (12) of the first support (2). The locking means could be interposed, for example, between the brackets (12,13) of the first and second supports (2,3).

The device according to the present invention can further comprise a casing (7) that encloses the second support (3) and renders it inaccessible. The casing (7) is made of a material that simulates the consistency of muscle and/or epithelial tissues, for example an elastomeric material (e.g. polyurethane foams, silicone, shape memory foams, etc.). In the case described, the casing (7) can be conformed so as to simulate the conformation and consistency of shoulder muscles. This enables the simulation of an arthroscopic intervention under extremely real conditions. For example, the surgeon can go over all the steps of a rotator cuff reconstruction intervention in a very realistic manner. In particular, after having inserted a camera and after having introduced the mechanical instrument for performing the abrasion and/or fashioning the hole on the head of the model of the humerus, the surgeon can rotate the second support (3) about the first axis (X), likewise rotating the model of the humerus until bringing the coronal plane of the humerus into the desired position, i.e. into alignment with the mechanical instrument. Preferably, the casing (7) is open at least on one side to allow manoeuvring of the second support (3). In the embodiment represented, the casing (7) is open in the area of the brackets (12,13) of the first and second supports (2,3).

The casing (7) can contain within it replaceable elements simulating the anatomical structures of a joint, wherein said replaceable elements simulate anatomical structures that are intact or represent specific pathologies and may or may not incorporate all or part of the surrounding soft tissues. In other words, the casing (7) can allocate various single-use or multi-use bone/tendon models, which have different anatomical details, and can incorporate not only intact anatomical models but also reconstruct defects and pathologies (e.g. defects of the head of the humerus, simulate alterations in cuff repairs, simulate glenoid bone loss, etc.).

In one possible embodiment, not illustrated, the device according to the present invention could be provided with a third support for a second bone model. By means of the second support (3) and the third support, it would therefore be possible to arrange two bone models so as to form a joint, for example of an elbow or knee. The third support could be rotatable both relative to the first support (2), and relative to the second support (3), so as to simulate various positions of the joint. In this embodiment, the casing (7) is conformed so as to enclose the second support and the third support, in order to render the two bone models inaccessible.

1. A device for simulating a surgical intervention, characterised in that it comprises:
a first support (2), which defines a first reference plane (2a) and a second reference plane (2b);
a second support (3), provided with a seat (31) for accommodating a portion of bone or of a bone model, which is associated with the first support (2) with the possibility of rotating about at least a first axis (X) parallel to a longitudinal axis of the portion of bone or bone model.

2. The device according to claim 1, wherein the first plane (2a) and the second plane (2b) are inclined relative to each other by a prefixed angle.

3. The device according to claim 1, wherein the first plane (2a) and the second plane (2b) are inclined relative to each other by an adjustable angle.

4. The device according to claim 1, wherein the first axis (X) is parallel to the second plane (2b).

5. The device according to claim 1, wherein: the first support (2) comprises a coupling seat (21) provided with cylindrical surface (22) concentric to the first axis (X); the second support (3) comprises a cylindrical surface (32) concentric to the first axis (X) and placed in contact with the coupling seat (21).

6. The device according to claim 1, comprising a manoeuvring means ( )configured to bring about the rotation of the second support (3) relative to the first support (2).

7. The device according to claim 1, comprising a locking means ( ) configured to lock the second support (3) in a desired angular position relative to the first support (2).

8. The device according to claim 1, comprising a casing (7) which encloses the second support (3) and renders it inaccessible, wherein the casing (7) is made of a material that simulates the consistency of muscular and/or epithelial tissues.

9. The device according to claim 8, wherein the casing (7) is made of elastomeric material.

10. The device according to claim 9, wherein the casing (7) contains within it replaceable elements which simulate the anatomical structures of a joint, wherein said replaceable elements simulate anatomical structures that are intact or represent specific pathologies and may or may not incorporate all or part of the surrounding soft tissues.
